(19) United States
(12) Patent Application Publication
(10) Pub. No.: US 2010/0219253 A1
(43) Pub. Date: Sep. 2, 2010

(54) RFID PRINTER

(75) Inventor: Akio Katsumata, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/712,433

(22) Filed: Feb. 25, 2010

(30) Foreign Application Priority Data
Feb. 27, 2009 (JP) 2009-047258

(51) Int. Cl. G06K 19/067

(52) U.S. Cl. 235/492

(57) ABSTRACT

An RFID printer includes a housing, a conveyance mechanism to convey an RFID tag along a guide path in the housing, an antenna which is disposed at one surface side of the guide path and a front surface of which is opposite to the guide path, a reader-writer to read and write data on the RFID tag positioned at a front surface side of the antenna by non-contact communication, and an electric wave shielding member which is made of metal, is disposed at a back surface side of the antenna, and has an opposite surface opposite to the back surface of the antenna and having a plurality of irregularities provided by hair-line processing.

### CROSS-REFERENCE TO RELATED APPLICATION

This application is based upon and claims the benefit of priority from Japanese Patent Application No. 2009-047258, filed on Feb. 27, 2009, the entire contents of the Japanese Patent Application are incorporated in this application by reference.

### TECHNICAL FIELD

The present invention relates to an RFID printer to perform data writing and the like on an RFID tag by non-contact communication.

### BACKGROUND

Hitherto, there is an RFID tag in which various information can be printed on a printing surface, and reading and writing of data can be performed by non-contact communication. As an example of the RFID tag, there is an RFID label in a label form in which labels are pasted on a long mount at regular intervals.

An RFID printer to convey an RFID label and to perform printing and data reading and writing becomes popular. The RFID printer includes an antenna arranged to be opposite to a communication area through which the RFID label passes, and performs data reading and writing on the RFID label by non-contact communication through the antenna.

The antenna radiates an electric wave from both sides of front and back surfaces. The electric wave radiated from the back surface of the antenna reaches an RFID label, which is not positioned in the communication area (non-contact communication should not be performed), other than an RFID label as a target, and data writing or the like is sometimes erroneously performed. Then, hitherto, in order to prevent erroneous writing by an unnecessary electric wave, an electric wave absorbing sheet to absorb the electric wave or an aluminum sheet to shield the electric wave is arranged in the housing.

However, there is a case where the electric wave shielding member has a surface (hereinafter referred to as an opposite surface) which is opposite to the antenna, has no irregularities, and mirror reflects the electric wave. Then, since the incident angle and the reflection angle of the electric wave with respect to the opposite surface become equal to each other, the electric wave is reflected (reflected wave) in the vertical direction by the electric wave shielding member, and the reflected wave passes through the antenna and reaches the RFID label. When the phase of the reflected wave is delayed (or advanced) by 180° from the phase of the electric wave as stated above, the electric wave and the reflected wave are synthesized in reverse phase and are remarkably weaken. As a result, there occurs a defect that data reading and writing can not be normally performed on the RFID label.

Then, in order to avoid that the RFID label is positioned at a point (null point) where the electric wave and the reflected wave cancel each other, it is conceivable to change the up-and-down position of the electric wave shielding member. However, since the null point is changed by slight change in environment, the defect is not resolved only by the up-and-down movement of the electric wave shielding member.

When the electric wave radiated from the back surface of the antenna can be diffusely reflected, since the electric wave and the reflected wave do not cancel each other in reverse phase, the defect is resolved. JP-A-2005-269085 and JP-A-2006-333026 are documents found from the viewpoint that the electric wave is reflected diffusely when the RFID is used. However, JP-A-2005-269085 and JP-A-2006-333026 do not disclose that how the surface to reflect the electric wave is processed. When the opposite surface of the electric wave shielding member is processed to have irregularities, the electric wave can be reflected diffusely. However, when the processing is not simple or a new member is required, there is a fear that design change of the RFID printer is required.

An object of the invention is to prevent, by a simple measure, the occurrence of a defect that data reading and writing is not normally performed on an RFID tag since an electric wave shielding member reflects an electric wave radiated from a back surface of an antenna.

### SUMMARY

According to an aspect of the invention, an RFID printer includes a housing, a conveyance mechanism to convey an RFID tag along a guide path in the housing, an antenna which is disposed at one surface side of the guide path and a front surface of which is opposite to the guide path, a reader-writer to read and write data on the RFID tag positioned at a front surface side of the antenna by non-contact communication, and an electric wave shielding member which is made of metal, is disposed at a back surface side of the antenna, and has an opposite surface opposite to the back surface of the antenna and having a plurality of irregularities provided by hair-line processing.

### DESCRIPTION OF THE DRAWINGS

FIG. 1 is a side sectional view schematically showing an RFID printer.

FIG. 2 is a perspective view showing an electric wave shielding member together with an antenna and a label sheet.

FIG. 3 is a schematic view showing the state of an electric wave radiated by the antenna.

### DETAILED DESCRIPTION

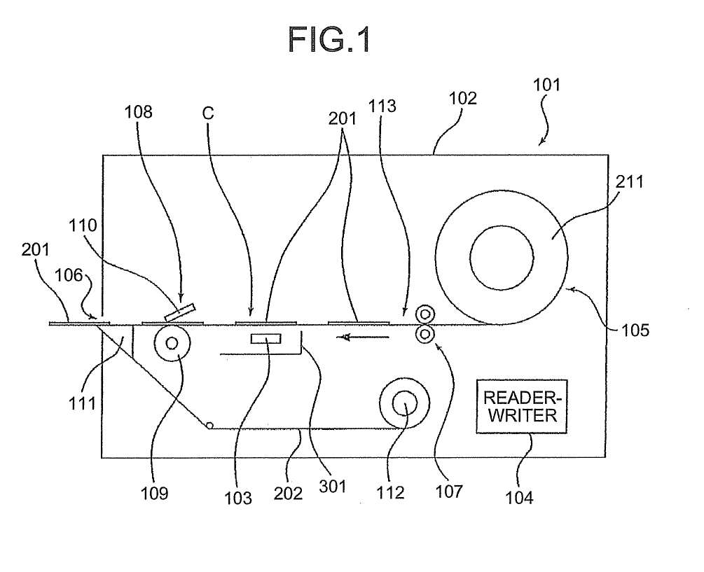

FIG. 1 is a side sectional view schematically showing an RFID printer 101. The RFID printer 101 includes a rectangular parallelepiped housing 102 containing respective sections. The housing 102 contains a holding section 105 to hold a label sheet 211 which is made to be freely pulled out and which is wound into a roll while RFID labels 201 are located on the inside thereof.

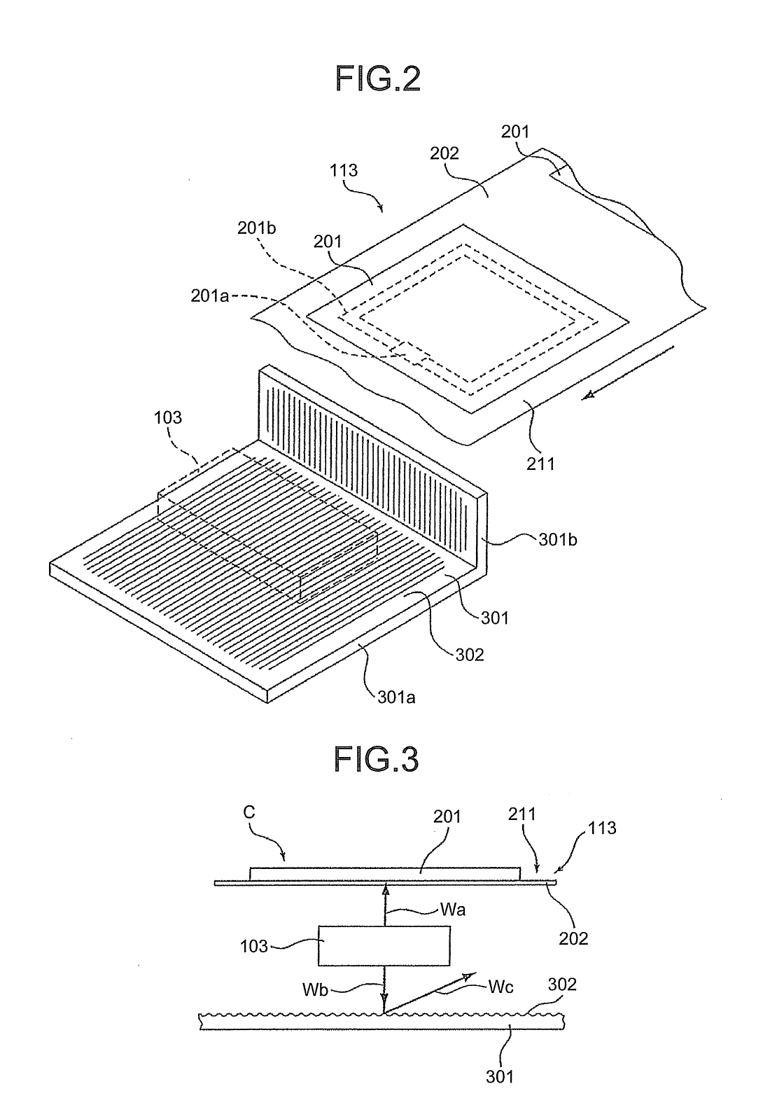

The surface of each of the RFID labels 201 of the label sheet 211 is a printing surface which is colored by heat application. Besides, the RFID 201 performs non-contact communication with an after-mentioned reader-writer 104. Thus, the RFID label 201 incorporates an IC chip 201a and a label antenna 201b (see FIG. 2). The RFID label 201 is a so-called passive type RFID tag which does not incorporate a battery. In this embodiment, a system of non-contact communication between the RFID label 201 and the reader-writer 104 is an electric wave system in which communication is performed using an electric wave of UHF (860 MHz to 960 MHz) band.

A rotating conveyance roller 107 applies a conveyance force to the label sheet 211 pulled out from the holding section 105, and conveys it to a front discharge port 106 of the housing 102. That is, the conveyance roller 107 conveys the label sheet 211 along a guide path 113 extending from the holding section 105 to the discharge port 106. The conveyance roller 107 includes a driving roller and a driven roller, and the driving roller is rotated and driven by a drive motor (not shown) as a drive source.

In the housing 102, an antenna 103 to perform non-contact communication with the RFID label 201 and a print section 108 to print on the RFID label 201 are arranged between the conveyance roller 107 and the discharge port 106. Besides, in the housing 102, the antenna 103 is disposed upstream of the print section 108 in a conveyance direction of the label sheet 211 (hereinafter referred to as a sheet conveyance direction).

The antenna 103 has a thin rectangular parallelepiped shape and incorporates a planar radiation element (not shown). In the housing 102, the antenna 103 is disposed to be opposite to the guide path 113. The antenna 103 is connected with the reader-writer 104 incorporated in the housing 102. A PC (not shown) connected to the RFID printer 101 controls the operation of the reader-writer 104. The conveyance roller 107 positions the RFID label 201 in an area (communication area C) opposite to the antenna 103, and stops the conveyance of the label sheet 211. The reader-writer 104 subjected to the operation control from the PC causes the antenna 103 to radiate an electric wave. In the RFID label 201 positioned in the communication area C, the label antenna 201b receives the electric wave radiated by the antenna 103 and generates electric power, and the IC chip 201a is activated. The activated IC chip 201a communicates with the reader-writer 104. When a communicable state is established, the reader-writer 104 reads data stored in the IC chip 201a or writes data into the IC chip 201a.

The directionality of the antenna 103 is in an upward direction in order to perform non-contact communication with the RFID label 201 positioned in the communication area C. The antenna 103 radiates an electric wave also from the surface (back surface) opposite to the surface (front surface) at the communication area C side.

The print section 108 includes a platen 109 disposed at the lower side of the conveyed label sheet 211, and a thermal head 110 which contacts with the platen 109 through the conveyed label sheet 211. The thermal head 110 includes heat generating elements (not shown) arranged in one line. The platen 109 is rotated and driven by a drive motor (not shown) as a drive source. The RFID printer 101 selectively causes the heat generating elements of the thermal head 110 to generate heat in accordance with the rotation of the platen 109, and prints on the printing surface of the RFID label 201.

In the housing 102, a peeling section 111 is disposed between the print section 108 and the discharge port 106. The peeling section 111 peels the RFID label 201 from a mount 202 of the conveyed label sheet 211 and discharges it from the discharge port 106. In the RFID printer 101, the mount 202 from which the RFID label 201 is peeled is folded along the peeling section 111, and is wound by a winding roller 112 incorporated in the housing 102.

In the housing 102, an electric wave shielding member 301 as a member made of metal (for example, aluminum) is disposed in a lower area of the antenna 103. Next, the electric wave shielding member 301 of the embodiment will be described with reference to FIG. 1 and FIG. 2.

FIG. 2 is a perspective view showing the electric wave shielding member 301 together with the antenna 103 and the label sheet 211. Incidentally, the antenna 103 of FIG. 2 is indicated by a broken line.

The electric wave shielding member 301 has such a shape that one metal plate is bent at right angles. That is, the electric wave shielding member 301 includes a rectangular main plate section 301a and a sub-plate section 301b rising vertically from one end of the main plate section 301a. In the housing 102, the electric wave shielding member 301 is arranged such that the main plate section 301a is parallel to the antenna 103. The upper end of the sub-plate section 301a reaches the height of the upper surface of the antenna 103. The length of the main plate section 301a in the sheet conveyance direction is longer than the length of the antenna 103 in the sheet conveyance direction. Besides, the length of the electric wave shielding member 301 in a width direction (direction orthogonal to the sheet conveyance direction) is longer than the length of the antenna 103 in the direction orthogonal to the sheet conveyance direction. That is, the electric wave shielding member 301 covers the lower area of the antenna 103 and the upstream side area of the antenna 103 in the sheet conveyance direction.

The conveyance roller 107 conveys the label sheet 211, and positions one RFID label 201 in the communication area C. At this time, the conveyance roller 107 causes another RFID label 201 positioned upstream of the communication area C in the sheet conveyance direction to be positioned upstream of the sub-plate section 301b of the electric wave shielding member 301 in the sheet conveyance direction.

At this time, the electric wave shielding member 301 covers the lower area of the antenna 103 and the upstream side area of the antenna 103 in the sheet conveyance direction, so that the electric wave radiated from the back surface of the antenna 103 does not reach another RFID label 201 positioned upstream of the communication area C in the sheet conveyance direction, and it is prevented that data reading and writing is erroneously performed.

As shown in FIG. 2, the electric wave shielding member 301 covers the antenna 103, and has a surface subjected to processing (hair-line processing) in which long and continuous polishing marks like hair are formed. In the hair-line processing, a sand block of an appropriate particle size (for example, abrasive grain of grain size No. 150 to 240) or a polishing belt is used. Since the hair-line processing technique is the well-known technique, its detailed description is omitted.

FIG. 3 is a schematic view showing the state of an electric wave radiated by the antenna 103. An electric wave Wa radiated in the vertical direction with respect to the antenna 103 from the surface of the antenna 103 goes straight and reaches the RFID label 201. Besides, the antenna 103 radiates an electric wave Wb in the vertical direction with respect to the antenna 103 from the back surface of the antenna. The metal electric wave shielding member 301 reflects the electric wave Wb (reflected wave Wc).

However, according to this embodiment, in the electric wave shielding member 301, since the opposite surface 302 opposite to the antenna 103 is subjected to the hair-line processing, the irregularities are formed of plural polishing marks. Thus, the incident angle and the reflection angle of the electric wave Wb are not equal to each other, and as shown in FIG. 3, the electric wave shielding member 301 diffusely reflects the reflected wave Wc by the opposite surface 302. Accordingly, the phase of the reflected wave Wc is delayed (or advanced) by 180° with respect to the phase of the electric wave Wa, and the reflected wave Wc does not reach the RFID label 201. That is, the electric wave shielding member 301 can prevent the occurrence of the defect that the electric wave Wa and the reflected wave Wc are synthesized in reverse phase and are weakened, and data reading and writing on the RFID label 201 is not normally performed.

Besides, according to the embodiment, an electric wave shielding member M of the related art has only to be replaced by the electric wave shielding member 301 having the opposite surface 302 subjected to the hair-line processing. That is, according to the embodiment, the widely and commonly performed hair-line processing is applied to the surface of the electric wave shielding member M of the related art, or a commonly available hair-line member can be adopted as the electric wave shielding member 301. Thus, according to the embodiment, the occurrence of the defect that data reading and writing on the RFID label 201 is not normally performed can be prevented by the very simple measure.

Incidentally, in the embodiment, as the pattern of the polishing marks on the opposite surface 302 of the electric wave shielding member 301 formed by the hair-line processing, the straight pattern along the conveyance direction of the RFID label 201 is shown (see FIG. 2). However, the pattern of the polishing marks of the opposite surface 302 is not limited to the straight pattern along the conveyance direction of the RFID label 201. For example, in the electric wave shielding member 301, the polishing marks of the opposite surface 302 may be formed along the direction orthogonal to the conveyance direction of the RFID label 201, or may be formed obliquely to the conveyance direction of the RFID label 201. Besides, in the electric wave shielding member 301, the pattern of polishing marks of the opposite surface 302 may be formed into an arc shape. Further, in the electric wave shielding member 301, the pattern of polishing marks of the opposite surface 302 may be a combination of the two or more patterns mentioned above. In any pattern of the polishing marks, since the opposite surface 302 has the irregularities, the incident angle and the reflection angle of the electric wave Wb are not equal to each other, and the reflected wave Wc is diffusely reflected by the opposite surface 302. That is, in any pattern of the polishing marks, the electric wave shielding member 301 has the same effect as the case (see FIG. 2) where the polishing marks are formed along the conveyance direction of the RFID label 201.

Further effects and modified examples can be easily led by one of ordinary skill in the art. Thus, a broader aspect of the present invention is not limited to specific details and representative embodiments that are represented and described above. Accordingly, various modifications can be made without departing from the spirit or the scope of the comprehensive concept of the invention that is defined by attached claims and their equivalents.

What is claimed is:

1. An RFID printer comprising:
a housing;
a conveyance mechanism to convey an RFID tag along a guide path in the housing;
an antenna which is disposed at one surface side of the guide path and a front surface of which is opposite to the guide path;
a reader-writer to read and write data on the RFID tag positioned at a front surface side of the antenna by non-contact communication; and
an electric wave shielding member which is made of metal, is disposed at a back surface side of the antenna, and has an opposite surface opposite to the back surface of the antenna and having a plurality of irregularities provided by hair-line processing.

2. The printer of claim 1, wherein the electric wave shielding member includes:
a plate-like main plate section having the opposite surface; and
a plate-like sub-plate section rising from an upstream end of the main plate section in an RFID tag conveyance direction.

3. The printer of claim 2, wherein
a length of the main plate section in the RFID tag conveyance direction is longer than the antenna, and a length of the main plate section in a direction orthogonal to the RFID tag conveyance direction is longer than the antenna, and
an upper end of the sub-plate section reaches an upper surface height of the antenna.

4. The printer of claim 2, wherein
the main plate section is arranged to be parallel to the antenna, and
the sub-plate section rises vertically from the upstream end of the main plate section in the RFID tag conveyance direction.

5. The printer of claim 1, wherein the opposite surface is provided with straight polishing marks along the RFID tag conveyance direction by hair-line processing.

6. The printer of claim 1, wherein the opposite surface is provided with polishing marks in a direction orthogonal to the RFID tag conveyance direction by hair-line processing.

7. The printer of claim 1, wherein the opposite surface is provided with arc-shaped polishing marks by hair-line processing.

8. The printer of claim 1, wherein the opposite surface is provided with polishing marks of a combination of a plurality of patterns by hair-line processing.

9. The printer of claim 2, wherein the conveyance mechanism causes another RFID tag positioned upstream of the RFID tag positioned at the surface side of the antenna in the RFID conveyance direction to be positioned upstream of the sub-plate section in the RFID tag conveyance direction.

10. The printer of claim 1, wherein the electric wave shielding member is an member made of aluminum.
